(19) United States
(12) Patent Application Publication
(10) Pub. No.: US 2011/0106703 A1
(43) Pub. Date: May 5, 2011

(54) COMPUTERIZED DEPOSIT ACCOUNT MANAGEMENT

(76) Inventors: Christopher S. Jay, Amherst, NH (US); Bradbury Hart, Amherst, NH (US)

(21) Appl. No.: 12/852,186

(22) Filed: Aug. 6, 2010

Related U.S. Application Data
(60) Provisional application No. 61/232,281, filed on Aug. 7, 2009.

(51) Int. Cl. G06Q 40/00

(52) U.S. Cl. 705/44

(57) ABSTRACT

Computer-implemented methods and systems are provided for managing a deposit account held by a financial institution. This includes receiving, via a computer network, a request to make a contribution to the deposit account by an electronic payment and interacting with a payment processing center for processing and authorization of the electronic payment. Upon authorization of the electronic payment, the contribution is transferred to the deposit account via a transfer interface that interfaces with the financial institution. In another aspect, a computer readable medium contains instructions for controlling a computing device to perform a method for managing a deposit account held by a financial institution.

### BACKGROUND OF THE INVENTION

This invention relates generally to managing deposit accounts and more particularly to facilitating management of deposit accounts electronically.

There are many options available for saving for a child's future. These include traditional bank accounts and savings bonds. However, there currently is no easily accessible resource that facilitates monetary contributions to a child's savings from a wide and diverse group of people, such as family members and close friends, that may desire to contribute to the child's savings and/or educational fund. For instance, if a child's relative lives in a different part of the country from the child, it is difficult for that relative to make a monetary contribution to the child's savings. This usually entails sending cash or a check through the mail. Furthermore, there is a lack of an effective mechanism for teaching children about the importance of saving for the future. Although parents can attempt to teach their children about saving for the future, there is no means available for teaching children about saving that children would generally find fun and engaging.

### SUMMARY OF THE INVENTION

In one embodiment, the present invention provides a computer-implemented method for managing a deposit account held by a financial institution. The method includes receiving, via a computer network, a request to make a contribution to the deposit account by an electronic payment and interacting with a payment processing center for processing and authorization of the electronic payment. Upon authorization of the electronic payment, the contribution is transferred to the deposit account via a transfer interface that interfaces with the financial institution.

In another embodiment, the present invention provides a computer-based system for managing a deposit account held by a financial institution. The system includes means for receiving, via a computer network, a request to make a contribution to the deposit account by an electronic payment and means for interacting with a payment processing center for processing and authorization of the electronic payment. Also includes are means for interacting with a transfer interface that interfaces with the financial institution to allow the contribution to be transferred to the deposit account.

In yet another embodiment, the present invention provides a computer readable medium containing instructions for controlling a computing device to perform the method for managing a deposit account held by a financial institution discussed above.

### DESCRIPTION OF THE DRAWINGS

FIG. 1 is a block diagram of a computer-based system for allowing users to manage deposit accounts held by participating financial institutions.

FIG. 2 illustrates a web page used for creating a membership account.

FIG. 3 illustrates the process flow for making a contribution using the system of FIG. 1.

FIG. 4 illustrates a web page used for making a contribution.

### DETAILED DESCRIPTION OF THE INVENTION

The present invention relates generally to systems, methods, and computer program products for facilitating management of deposit accounts held with financial institutions. As used herein, a “deposit account” refers to any type of account (such as savings accounts, checking accounts, money market accounts and the like) held at a financial institution in which funds can be deposited and withdrawn by the account holder. The term “financial institution” refers to any entity that provides deposit account services; “financial institutions” include, but are not limited to, banks, credit unions, and savings and loan associations.

In one embodiment, a service provider provides deposit account management services to participating members. These members are able to manage deposit accounts held with participating financial institutions via a website operated by the service provider. As used herein, a “member” refers to a user who has created a membership account with the service provider; a member is typically a person but could also be an entity such as a business or organization. Also, for convenience, when any person or entity is referred to by a singular pronoun (e.g. he, she, it, etc.) this generally will be presented in the masculine gender, with the understanding that this includes individuals of both genders as well as gender-neutral entities. A “participating financial institution” refers to a financial institution that has agreed to participate in the account management system. Although a financial institution could function as the service provider, the service provider need not be a financial institution and typically is not affiliated with any of the participating financial institutions other than the financial institutions' agreement to participate in the account management system.

One feature of the account management system is it enables various contributors to make electronic deposits to members' deposit accounts. A contributor is able to make a deposit to the desired deposit account (i.e., the destination account) by accessing the service provider's website. A contributor can be the member who holds the deposit account to which the deposit is being made, or a contributor can be someone other than the member who holds the deposit account. The latter type of contributors can be either members of the service or non-members. Users are able to make contributions electronically through a variety of electronic funds transfer (EFT) techniques (such as credit cards, debit cards, stored-value cards, electronic checks (e-checks), wire transfers, etc.), and the system's underlying computer programming makes sure that all contributions end up in the destination deposit account. The contributor does not need to know the destination deposit account details or even the actual financial institution that holds the destination deposit account. Because the contributions are made electronically via the website, there are virtually no geographic limitations on contributions. Contributors are able to make contributions from anywhere in the world as long as they have Internet access. Recipients and contributors are both able to track and monitor their contributions by accessing the service provider's website.

The account management system is particularly well suited to providing a mechanism for allowing children to save. For instance, a parent can create a membership account with the service provider for a child, set up a deposit account at a participating financial institution for the child, and associate or link the deposit account with the child's membership account. This provides an online mechanism that facilitates monetary contributions to the child's deposit account. Friends, family, and relatives can easily contribute to the child's deposit account for any reason, such as contributions to an educational fund, birthday or holiday gifts, weekly allowances, rewards for good report cards, payments for chores or baby-sitting, etc. Moreover, the child will be given an opportunity to learn about the importance of saving for the future. The account management system isn't just for children, however, as it can provide a vehicle for anyone to accept electronic payments.

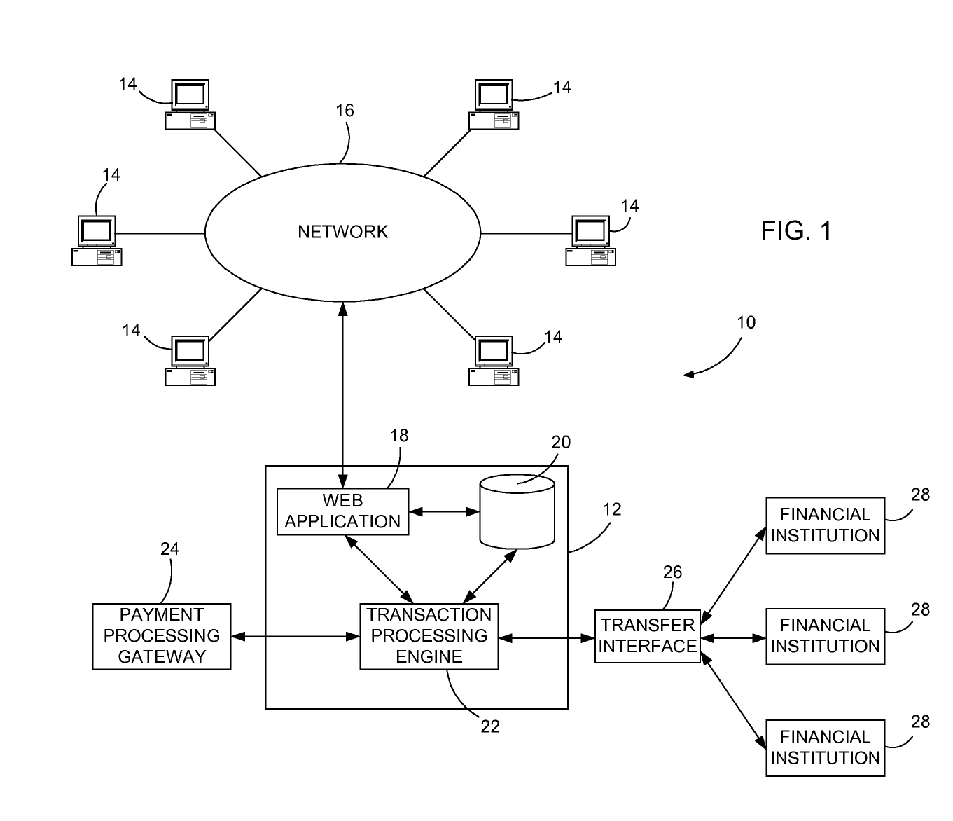

Referring to the drawings wherein identical reference numerals denote the same elements throughout the various views, FIG. 1 shows one embodiment of computer-based system 10 for allowing users to manage deposit accounts held by participating financial institutions. The system 10 includes a host computer 12 and a plurality of user computers 14 connected by a computer network 16. The computer network 16 is typically the Internet, although it is possible to employ other types of computer networks such as a local area network or a wide area network. By using the Internet as the computer network 16, the system 10 is able to access the distributed collection of interlinked, computer viewable hypertext documents (commonly referred to as web pages) that make up the “World Wide Web” (or simply the “Web”). As is known in the art, such hypertext documents or web pages are accessed with client and server software using standard Internet protocols such as Transmission Control Protocol/Internet Protocol (TCP/IP) and Hypertext Transport Protocol (HTTP). Currently, HTTP is a primary protocol for allowing applications to locate and acquire web pages, and web pages are notated with Hypertext Markup Language (HTML). However, as used herein, the terms “hypertext documents” and “web pages” are intended to encompass not only HTTP and HTML, but also any current or future transport protocols or markup languages that may be used instead of, or in addition to, HTTP and HTML.

The user computers 14 may be any type of computing devices that are capable of transmitting requests for and receiving web pages over the network 16. As used herein, the term “computing device” refers to any type of device that is capable of processing data based on a list of instructions. By way of example, but not limitation, the user computers 14 can include personal computers, desktop computers, laptop computers, handheld computers, personal digital assistants (PDAs), smartphones, and the like. As will be described in more detail below, the user computers 14 can be utilized by any user (contributor or recipient, member or non-member) to access the service provider's website.

The host computer 12, which can be implemented as a single, standalone computing device or as multiple computing devices linked together, is typically a server computer but can be any type of computing device. The host computer 12 includes computer programming, referred to herein as the account management software, which controls the management of the deposit accounts, including contributions made to deposit accounts. The account management software typically resides within one or more computer readable media of the host computer 12. For instance, the account management software could be loaded onto a non-removable computer readable medium of the host computer 12 or it could be stored on a removable computer readable medium (such as a floppy disk, CD-ROM or the like) inserted into the appropriate drive of the host computer 12 and accessed from there. Alternatively, the account management software could reside on a remote computer readable medium and be accessed by the host computer 12 via the computer network 16. As used herein, the term “computer readable medium” refers generally to any medium (including both volatile and non-volatile media, as well as removable and non-removable media) from which stored data can be read by a computing device. Computer readable media include, but are not limited to, hard disks, floppy disks, magnetic cassettes, flash memory cards, flash drives, optical media such as a CD-ROM, CD-R, CD-RW, DVD-ROM, DVD-RAM and the like, random access memories (RAMs), read only memories (ROMs), and other integrated circuit memory devices.

In the illustrated embodiment, the host computer 12 comprises a web application 18, a database 20, and a transaction processing engine 22, all of which are capable of interacting with one another. The web application 18 accesses the computer network 16 and provides users with the ability to interface with the account management software via the user computers 14. This allows the user computers 14 to access the web pages stored on the host computer 12, as well as other data stored on any other server systems connected to the network 16. Generally, the web application 18 receives requests to access web pages from one or more of the user computers 14 and provides the web pages to the requesting user computers 14. Users are able to input information to the web application 18 via the interactive web pages. The database 20 stores data relating to memberships and transactions. The transaction processing engine 22 processes transactions and interacts with other elements of the system 10. Specifically, the transaction processing engine 22 interacts, through any suitable secure communication link, with a payment processing gateway 24. The payment processing gateway 24 is a mechanism for processing and authorizing electronic payments by facilitating the transfer of information between the transaction processing engine 22 and the financial institution responsible for the electronic payment (e.g., a credit card issuer). The transaction processing engine 22 also interacts, through any suitable secure communication link, with a transfer interface 26 that interfaces with the participating financial institutions 28 to allow contributions to be transferred to member deposit accounts held by the financial institutions 28. The transfer interface 26 can comprise a financial transaction network such as the Automated Clearing House (ACH) or a direct link to the backend of the financial institution 28.

The system 10 can be used by members to track contributions made to their deposit accounts and otherwise manage their membership accounts. The system 10 can also be used by members or non-members to make contributions to a member's deposit account. Thus, users can be members or non-members. Members can be a recipient, a contributor, or both. Non-members can be contributors only. As used herein, a “recipient” refers to a member to which a contribution is made.

To be able to receive deposit account contributions via the system 10, a recipient must be a member of the account management service (that is, have created a membership account with the service provider) and have a deposit account with a participating financial institution that is associated with the recipient's membership account.

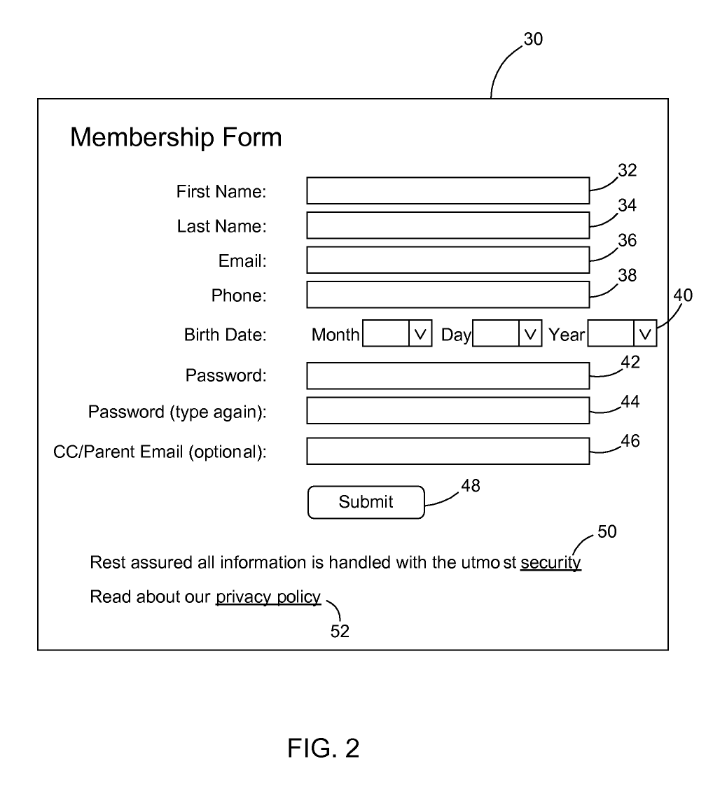

A user can set up a membership account with the service provider by using a user computer 14 to access the service provider's website and then provide the necessary data. The type of data generally needed will include the member's name, e-mail address, and phone number. By way of example, FIG. 2 shows an exemplary input page 30 displayed on the user computer 14 when a user creates a membership. The input page 30 includes a number of input boxes that allow the user to enter requested information that will be used to create a membership profile for the user. Each of the input boxes is labeled with a description of the type of data to be entered to guide the user in entering the proper data therein. Information can be entered directly into the input box, or in some instances, information can be entered by selecting inputs from a pull-down menu. In the illustrated embodiment, eight input boxes are provided. The first input box 32 is for entering the user's first name, and the second input box 34 is for entering the user's last name. The user's primary e-mail address is entered in the third input box 36; all e-mail communications from the service provider and contributors will be sent to this e-mail address. The fourth input box 38 receives the user's telephone number. The fifth input box 40 includes three pull-down menus providing lists of months, days and years that enable the user to enter his birth date. The user enters a password of his choosing in the sixth input box 42 and repeats the same password again in the seventh input box 44 for a confirmation of the intended password. This establishes the password for the user's membership account. In the eighth input box 46, an optional secondary e-mail address can be entered. The user will enter this if he desires to have communications from the service provider copied to this secondary e-mail address, in addition to being sent to the primary e-mail address. For example, this secondary e-mail address could be a parent's e-mail address where there member is a child.

Once the information is entered into the input boxes, the user can select the “Submit” button 48. This will cause the account management software to create a membership account for the user and use the provided information to generate a membership profile that is stored in the database 20. A member is able to view his membership profile by accessing his “profile page” on the service provider's website. The system 10 also can be configured to allow members to add additional items to their membership profiles. Possible additional items include, but are not limited to, pictures and personal messages. The input page 30 can also include links to additional information, such as a link 50 to information about the system's security and a second link 52 to information about the service provider's privacy policy.

Once a membership account is created, a second input page (not shown) is displayed that prompts the new member to enter information about his deposit account that he would like to link to his newly created membership account so that the account management system can transfer contributions to the chosen deposit account. The information generally needed includes the name of the financial institution and the account suffix of the deposit account.

Members are also able to establish a “savings network,” which is a group or network of other members (such as friends and family members) that are linked together. When a member is part of a savings network, a list of all of the members in the savings network can be accessed from that member's profile page and the member is able to view pictures and personal messages of the other members in the savings network. To add members to a savings network, a member can select or click on an “Add to Network” button on his profile page and then enter the username and e-mail address of the member to be added to the savings network. In addition, the system 10 can be configured such that when a member uses the system 10 to make a contribution to another member's deposit account, that member is automatically added to the contributing member's savings network. Members can also access their profile page to modify their profile (e.g., change or update their password, e-mail address, picture, personal message, etc.).

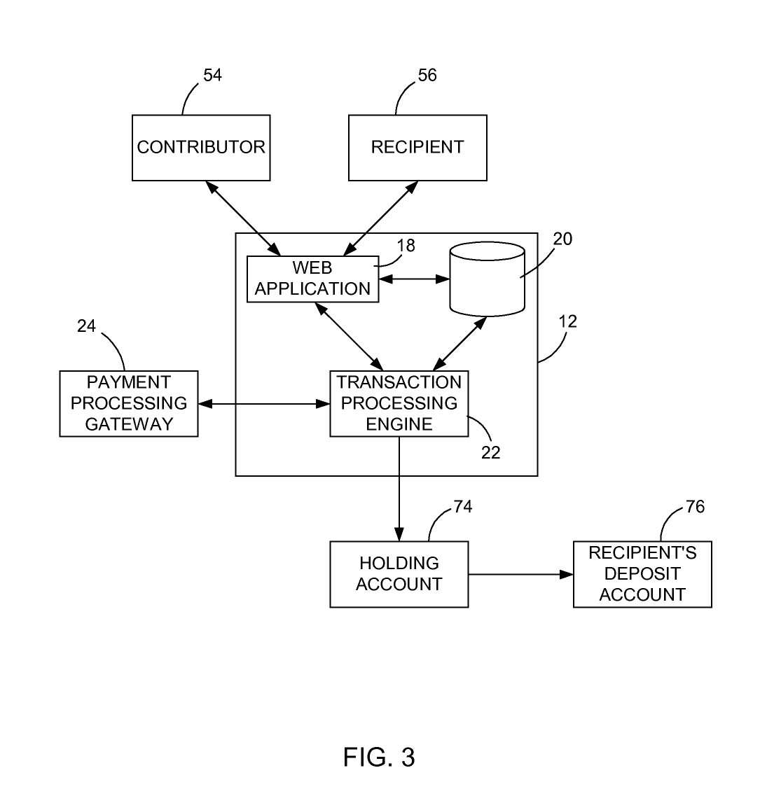

Referring to FIG. 3, the process flow of a contributor 54 using the system 10 to make a contribution to a recipient 56 is illustrated. The contribution process begins with the contributor 54 accessing the service provider's website (on the host computer 12) and inputting data pertinent to the contribution. As mentioned above, the contributor 54 can be either a member of the service or a non-member. To make a contribution into a member's deposit account, a non-member contributor first accesses the service provider's website with one of the user computers 14 and initiates the contribution function. For instance, the initial web page presented on the service provider's website could include a “Contribute” button. When the contributor 54 clicks on this “Contribute” button, another web page is presented that prompts the contributor 54 to enter his name and e-mail address for identification and communication purposes. Next, the contributor 54 is presented with a web page that prompts him to identify the recipient 56 of the contribution. Generally, this requires the contributor 54 to input identifying information, such as the recipient's membership ID and e-mail address.

Member contributors are able to make contributions by accessing the service provider's website and logging in as a member. Log in is typically accomplished by entering the appropriate identifying information, such as username and password, in a log-in section on the service provider's website. After logging in, the contributor 54 clicks on a “Contribute” button displayed on the web page and this takes the contributor to a web page that displays the members in his savings network. The contributor 54 then selects the member from his savings network to whom he wishes to make a contribution (i.e., recipient 56). Alternatively, member contributors can make “Out-of-Network” contributions in a manner similar to the non-member contribution process described above.

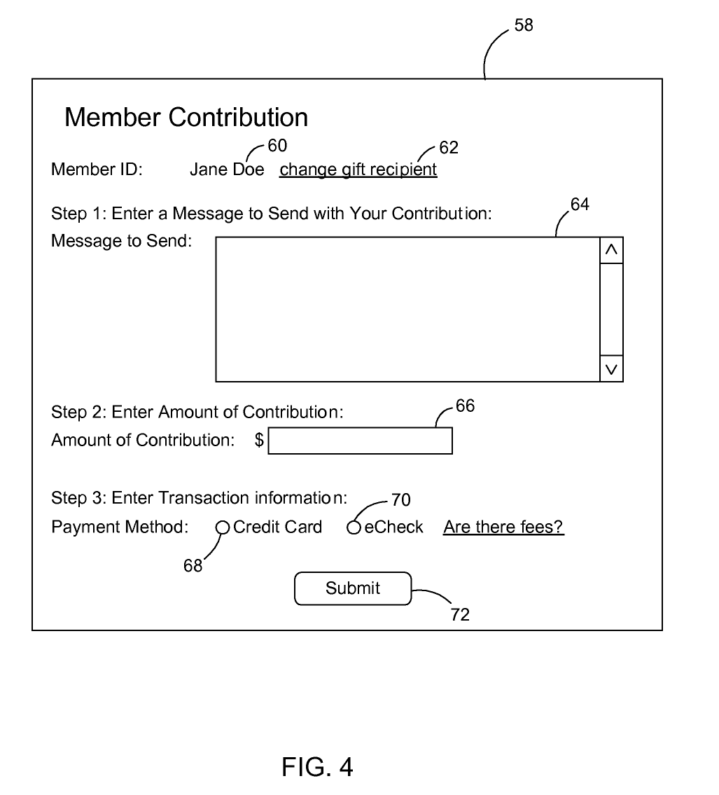

With either approach, once the contributor 54 has identified the desired recipient 56, a contribution page 58, such as the one depicted in FIG. 4 is displayed on the user computer 14 being employed by the contributor 54. The contribution page 58 displays the identified recipient's name 60 so that the contributor 54 is able to verify that the intended recipient 56 has been correctly identified. A link 62 is provided that enables the contributor 54 to change the recipient 56 if the intended recipient has not been correctly identified or if the contributor 54 changes his mind and decides to make a contribution to a different recipient. The contribution page 58 includes a first input box 64, together with explanatory indicia. The contributor 54 is able to enter a message into the first input box 64 that will be sent to the recipient 56. A second input box 66 with explanatory indicia is provided for allowing the contributor 54 to enter the amount of the contribution to be made to the recipient's deposit account. The contribution page 58 further includes a section that enables the contributor 54 to designate the method of payment to be used. In the illustrated embodiment, this includes two radio buttons: a first radio button 68 corresponding to payment by credit card and a second radio button 70 corresponding to payment by eCheck. The contributor 54 designates the payment method he wishes to use by selecting the appropriate radio button 68, 70. The credit card and eCheck payment options are shown here only by way of example. It should be understood that any type of suitable payment method could be included.

After entering the requested information, the contributor 54 can select the “Submit” button 72 on the contribution page 58, which causes instructions to be displayed to guide the contributor 54 through the rest of the process. Specifically, the contributor 54 will be prompted to enter payment information depending on the chosen payment method. For instance, if the contributor 54 elected to pay by credit card, he would be prompted to enter the pertinent data such as credit card number, expiration date and security code. If the contributor 54 elected to pay by eCheck, he would be prompted to enter the routing number and account number of the eCheck account. The payment information is preferably entered via any suitable security measures, such as SSL (Secure Sockets Layer) encrypted web form.

Referring again to FIG. 3, once the contributor 54 has submitted the contribution to the host computer 12, transaction processing engine 22 verifies whether the recipient's information is accurate and whether the recipient has a linked deposit account. The transaction processing engine 22 also verifies the payment information inputted by the contributor 54 and then submits the payment information to the payment processing gateway 24 for processing. The contribution transaction is stored in the database 20 with a status of “Submitted” and also appears in the contributor's “Contributions” page. The transaction processing engine 22 causes funds equal to the amount of the contribution to be charged to the financial institution responsible for the electronic payment, and the funds are transferred into a holding account 74. The transaction processing engine 22 downloads settlement files on a regular basis (e.g., daily) from the payment processing gateway 24. When a new settlement file is received, it is automatically examined and compared to the “Submitted” contribution transactions stored in the database 20. A contribution transaction that matches a settlement file is then cleared for transfer, and its status is changed to “Cleared.”

Once the funds have cleared, they are transferred from the service provider's holding account 74 into the recipient's deposit account 76 held at his financial institution. Specifically, the transaction processing engine 22 initiates a transfer for each “Cleared” contribution transaction from the holding account 74 into the recipient's deposit account 76 and marks the contribution transaction as “Transferred.” The transaction processing engine 22 accomplishes this by linking to the destination financial institution through the transfer interface 26, verifying the recipient's account, and transferring the funds to the recipient's account.

Upon completion of the transfer, the web application 18 sends a confirmation e-mail to the contributor 54, confirming that the contribution has been deposited. In addition, a notification e-mail is sent the recipient 56, which notifies the recipient 56 that a contribution has been made to his deposit account 76. The notification e-mail can include a link reminding the recipient 56 to thank contributor 54. The recipient 56 can access the transaction record via the website. The recipient 56 can click a “Send Thank You” button on the transaction record to cause a thank you e-mail message to be sent by the web application 18 to the contributor 54.

While specific embodiments of the present invention have been described, it should be noted that various modifications thereto can be made without departing from the spirit and scope of the invention as defined in the appended claims.

What is claimed is:

1. A computer-implemented method for managing a deposit account held by a financial institution, said method comprising:
receiving, via a computer network, a request to make a contribution to said deposit account by an electronic payment;
interacting with a payment processing center for processing and authorization of said electronic payment; and
transferring, upon authorization of said electronic payment, said contribution to said deposit account via a transfer interface that interfaces with said financial institution.

2. The computer-implemented method of claim 1 wherein the step of receiving, via a computer network, a request to make a contribution to said deposit account by an electronic payment comprises:
causing one or more input pages that prompt a user to input data pertinent to said contribution to be displayed on a user computer connected to said computer network; and
receiving data pertinent to said contribution that is inputted by said user.

3. The computer-implemented method of claim 2 wherein said data pertinent to said contribution includes the amount of said contribution and electronic payment information.

4. The computer-implemented method of claim 1 wherein the step of interacting with a payment processing center for processing and authorization of said electronic payment comprises:
submitting the amount of said contribution and electronic payment information to said payment processing center;
periodically downloading settlement files from said payment processing center;
examining said settlement files to clear said electronic payment.

5. The computer-implemented method of claim 4 further comprising transferring funds equal to the amount of said contribution to a holding account and transferring said funds from said holding account to said deposit account via said transfer interface after said electronic payment is cleared.

6. The computer-implemented method of claim 5 further comprising sending an e-mail message indicating that said funds have been deposited in said deposit account.

7. The computer-implemented method of claim 1 further comprising:
causing one or more input pages that prompt a user to input data relating to said deposit account to be displayed on a user computer connected to said computer network; and
receiving data relating to said deposit account that is inputted by said user.

8. A computer-based system for managing a deposit account held by a financial institution, said system comprising:
means for receiving, via a computer network, a request to make a contribution to said deposit account by an electronic payment;
means for interacting with a payment processing center for processing and authorization of said electronic payment; and
means for interacting with a transfer interface that interfaces with said financial institution to allow said contribution to be transferred to said deposit account.

9. The computer-based system of claim 8 further comprising means for causing one or more input pages that prompt a user to input data pertinent to said contribution to be displayed on a user computer connected to said computer network.

10. The computer-based system of claim 8 wherein said means for interacting with a payment processing center submits the amount of said contribution and electronic payment information to said payment processing center and periodically downloads settlement files from said payment processing center to clear said electronic payment.

11. The computer-based system of claim 10 further comprising means for transferring funds equal to the amount of said contribution to a holding account and means for transferring said funds from said holding account to said deposit account via said transfer interface after said electronic payment is cleared.

12. The computer-based system of claim 11 further comprising means for sending an e-mail message indicating that said funds have been deposited in said deposit account.

13. The computer-based system of claim 8 further comprising a database for storing information relating to said deposit account.

14. A computer readable medium containing instructions for controlling a computing device to perform a method for managing a deposit account held by a financial institution wherein said method comprises:
receiving, via a computer network, a request to make a contribution to said deposit account by an electronic payment;
interacting with a payment processing center for processing and authorization of said electronic payment; and
transferring, upon authorization of said electronic payment, said contribution to said deposit account via a transfer interface that interfaces with said financial institution.

15. The computer readable medium of claim 14 wherein the step of receiving, via a computer network, a request to make a contribution to said deposit account by an electronic payment comprises:
causing one or more input pages that prompt a user to input data pertinent to said contribution to be displayed on a user computer connected to said computer network; and
receiving data pertinent to said contribution that is inputted by said user.

16. The computer readable medium of claim 14 wherein the step of interacting with a payment processing center for processing and authorization of said electronic payment comprises:
submitting the amount of said contribution and electronic payment information to said payment processing center;
periodically downloading settlement files from said payment processing center;
examining said settlement files to clear said electronic payment.

17. The computer readable medium of claim 16 wherein said instructions transfer funds equal to the amount of said contribution to a holding account and transfer said funds from said holding account to said deposit account via said transfer interface after said electronic payment is cleared.

18. The computer readable medium of claim 17 wherein said instructions send an e-mail message indicating that said funds have been deposited in said deposit account.

19. The computer readable medium of claim 14 wherein said instructions:
cause one or more input pages that prompt a user to input data relating to said deposit account to be displayed on a user computer connected to said computer network; and
receive data relating to said deposit account that is inputted by said user.
